(19) United States
(12) Patent Application Publication
(10) Pub. No.: US 2026/0268354 A1
(43) Pub. Date: Sep. 10, 2026

(54) SYSTEM

(71) Applicant: SOFTBANK GROUP CORP., Tokyo (JP)

(72) Inventor: Tomoya AIZAWA, Tokyo (JP)

(73) Assignee: SOFTBANK GROUP CORP., Tokyo (JP)

(21) Appl. No.: 19/557,295

(22) Filed: Mar. 5, 2026

Related U.S. Application Data
(60) Provisional application No. 63/767,982, filed on Mar. 6, 2025.

(51) Int. Cl. G06Q 30/0202

(52) U.S. Cl. CPC G06Q 30/0202

(57) ABSTRACT

A system for efficiently evaluating the market acceptability of new business services is provided. It uses generative AI to generate simulated users with diverse attributes and provides detailed service information to these users. By simulating the reactions of simulated users and aggregating/analyzing the obtained data, it assesses the service's market potential, identifies target user segments, optimizes pricing, and evaluates competitive advantages. This enables rapid and low-cost enhancement of a new business service's success potential without conducting large-scale surveys. An example prompt fed to the generative AI is: "Predict how consumers in a specific age group will react to a new product."

### CROSS-REFERENCE TO RELATED APPLICATION

This application claims priority under 35 U.S.C. § 119 to U.S. Provisional Patent Application No. 63/767,982, filed on March 6, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

A system and method for improving the efficiency and reducing the cost of verifying the effectiveness of ideas for new business services is provided. Conventionally, methods such as large-scale questionnaire surveys and focus group interviews have been used to evaluate the market acceptability of new business services. However, these methods require significant time and expense, and there was the challenge of ensuring survey participants correctly understood the service. Furthermore, it was not easy to gather survey participants accurately reflecting the actual market, resulting in limitations on the reliability and reproducibility of the obtained data.

The disclosure aims to solve the above challenges by utilizing generative AI to create simulated users with diverse attributes. It provides these simulated users with information about the new business service and simulates their reactions. This enables rapid and low-cost evaluation of the service's acceptance among diverse user segments reflecting the actual market.

Furthermore, statistically analyzing the simulated users' response data provides insights essential for formulating business strategies, such as identifying the service's market potential, pinpointing target user segments, optimizing pricing, and evaluating competitive advantages. Therefore, this invention provides an effective means to enhance the likelihood of success for new business services prior to their market launch.

As a means to solve the problem, the disclosure provides a system comprising a generative AI unit, a pseudo-user generation unit, an information provision unit, a response simulation unit, and a data aggregation and analysis unit. The Generative AI Unit has the capability to generate pseudo-users with diverse attributes based on actual demographic data and market research data. This enables the creation of pseudo-users designed to reflect the actual market. The Pseudo-User Generation Unit generates users with a wide range of profiles, considering factors such as age, gender, occupation, income, residence, education level, hobbies, and lifestyle.

The Information Provision Unit has the function of providing detailed information about the new business service to the generated pseudo-users. This information includes the purpose, features, benefits, usage methods, and pricing of the service and is customized according to the simulated user's profile. This enables the simulated user to correctly understand the service and provide an appropriate response.

The Response Simulation Unit has the function of simulating responses for each pseudo-user based on their profile. These responses include the degree of interest in the service, purchase intent, price sensitivity, and comparative evaluation with competing services. This enables the rapid and low-cost evaluation of the service's market acceptability.

The Data Aggregation and Analysis Unit aggregate reaction data obtained from pseudo-users and analyzes it using statistical methods. This analysis enables the evaluation of the service's market potential, identification of target user segments, optimization of pricing, and assessment of competitive advantages. This provides the insights necessary for formulating business strategies, thereby increasing the likelihood of success before launching new business services into the market.

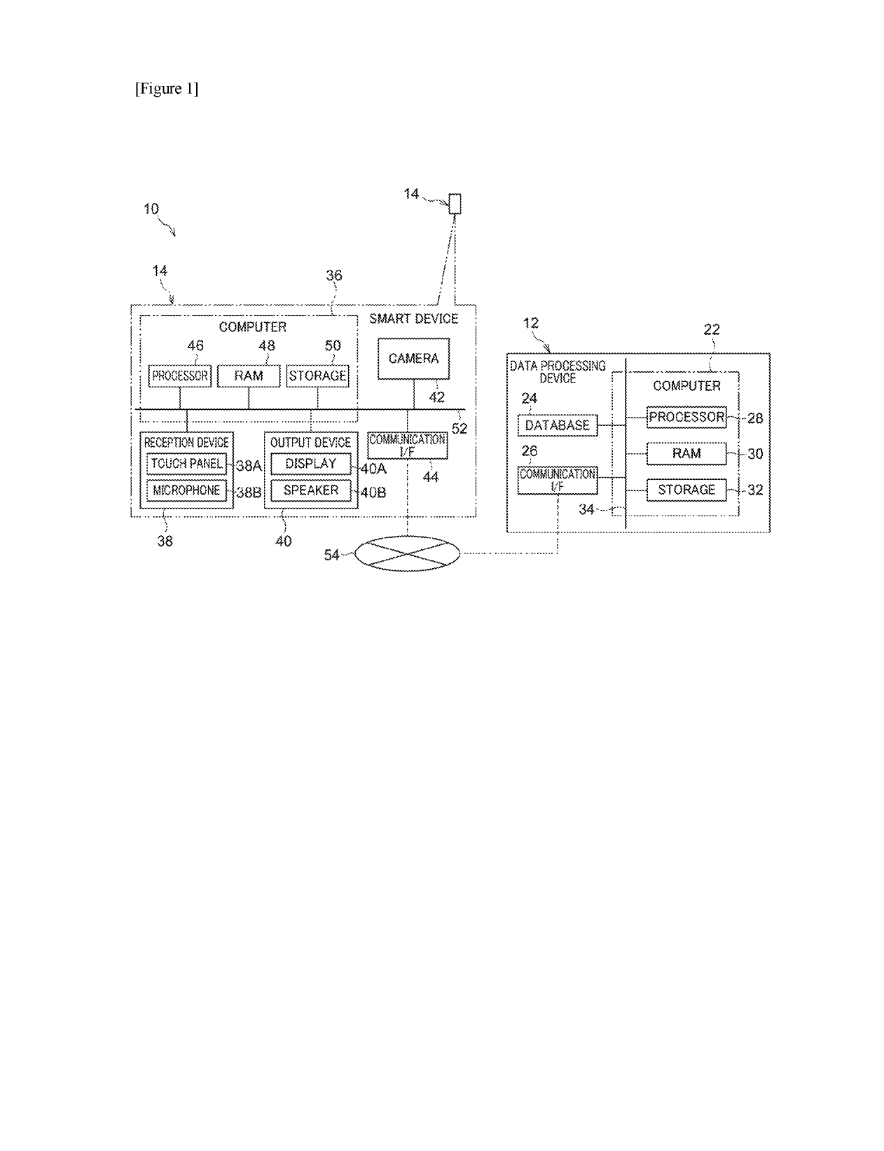

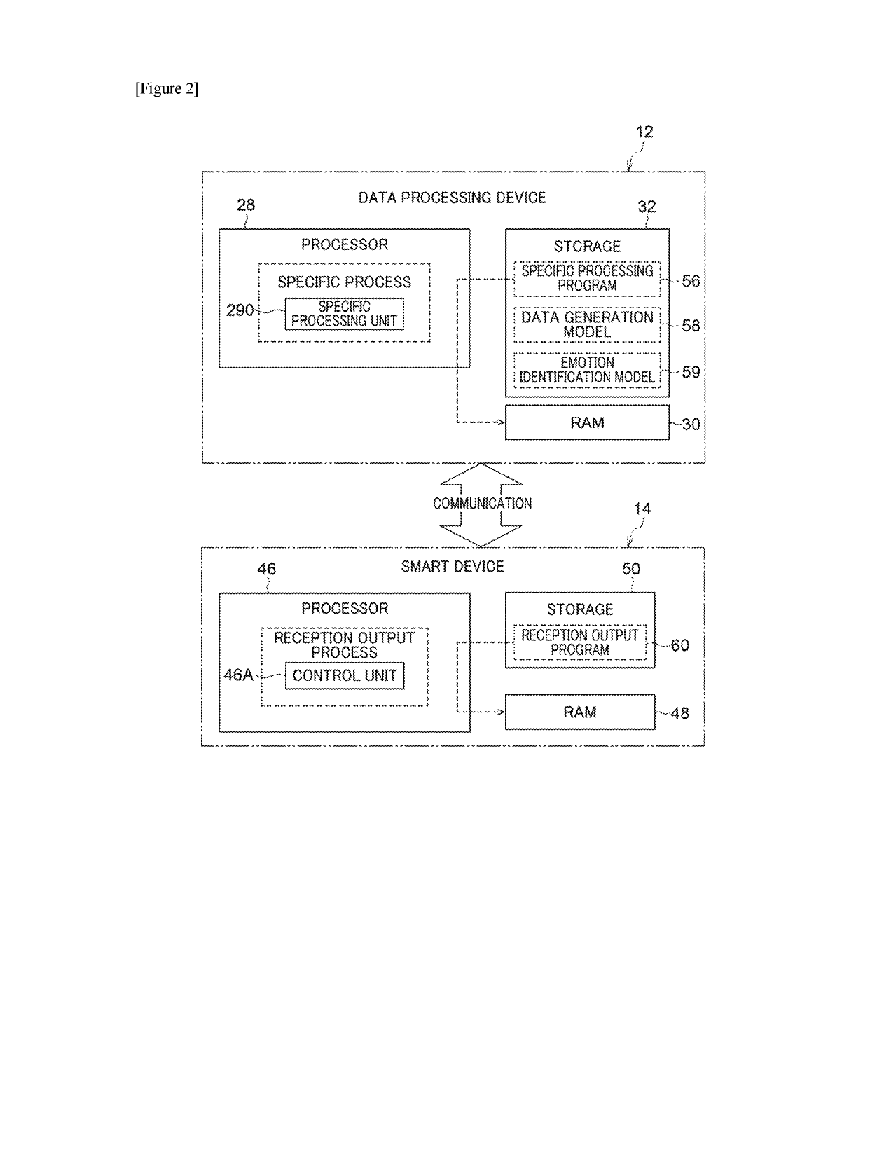

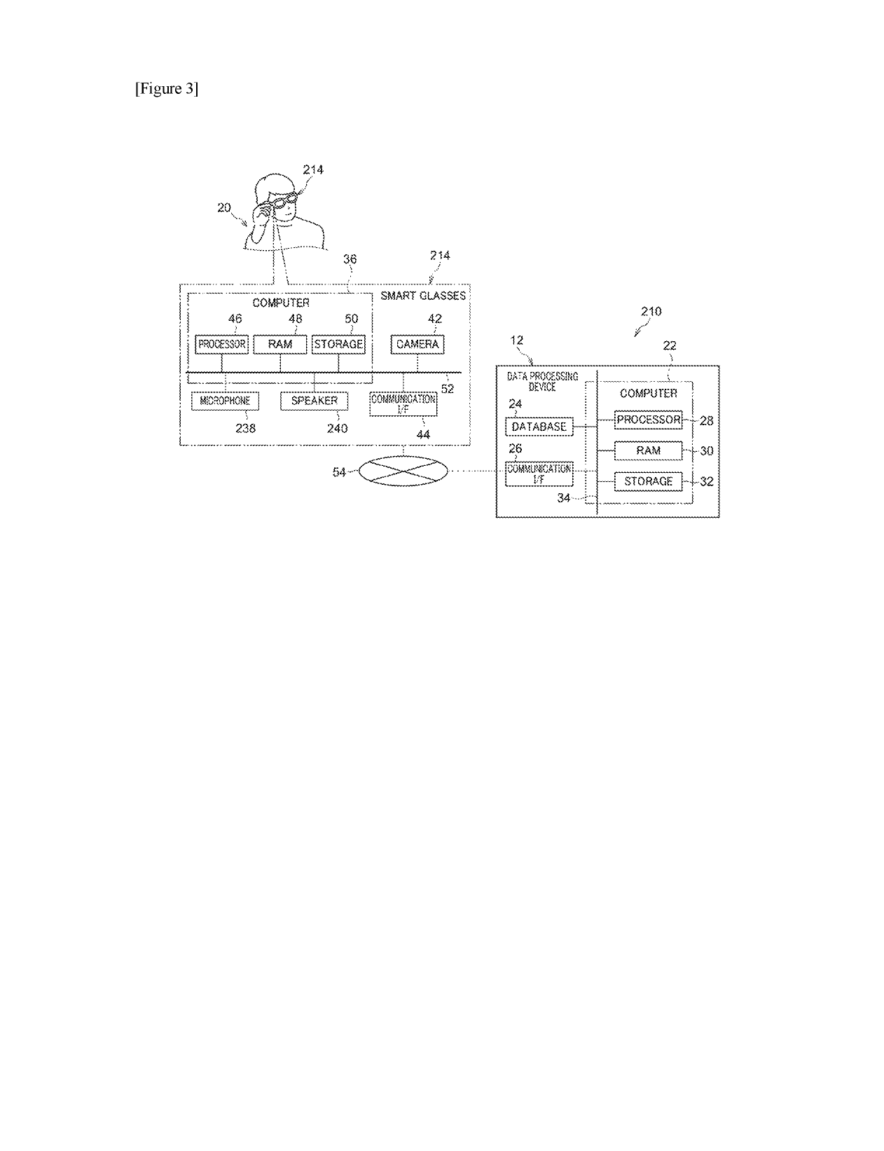

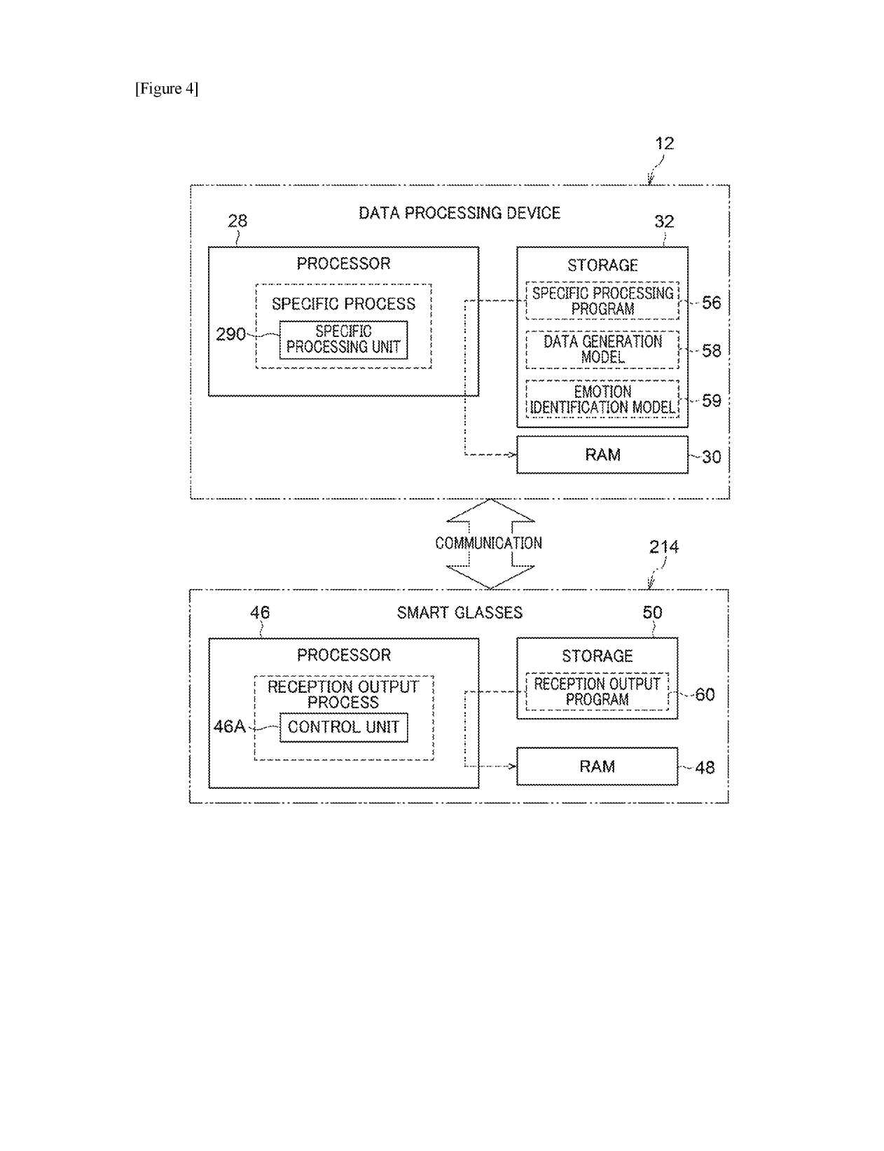

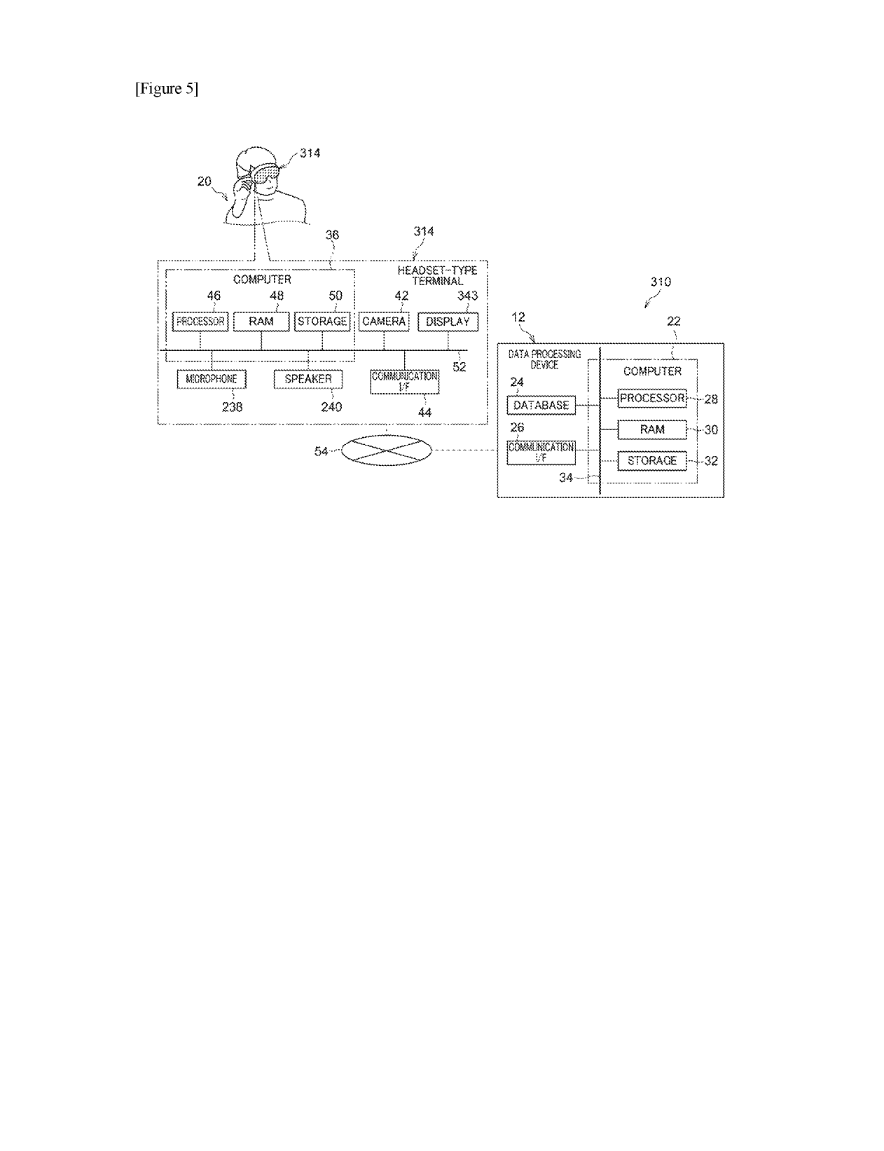

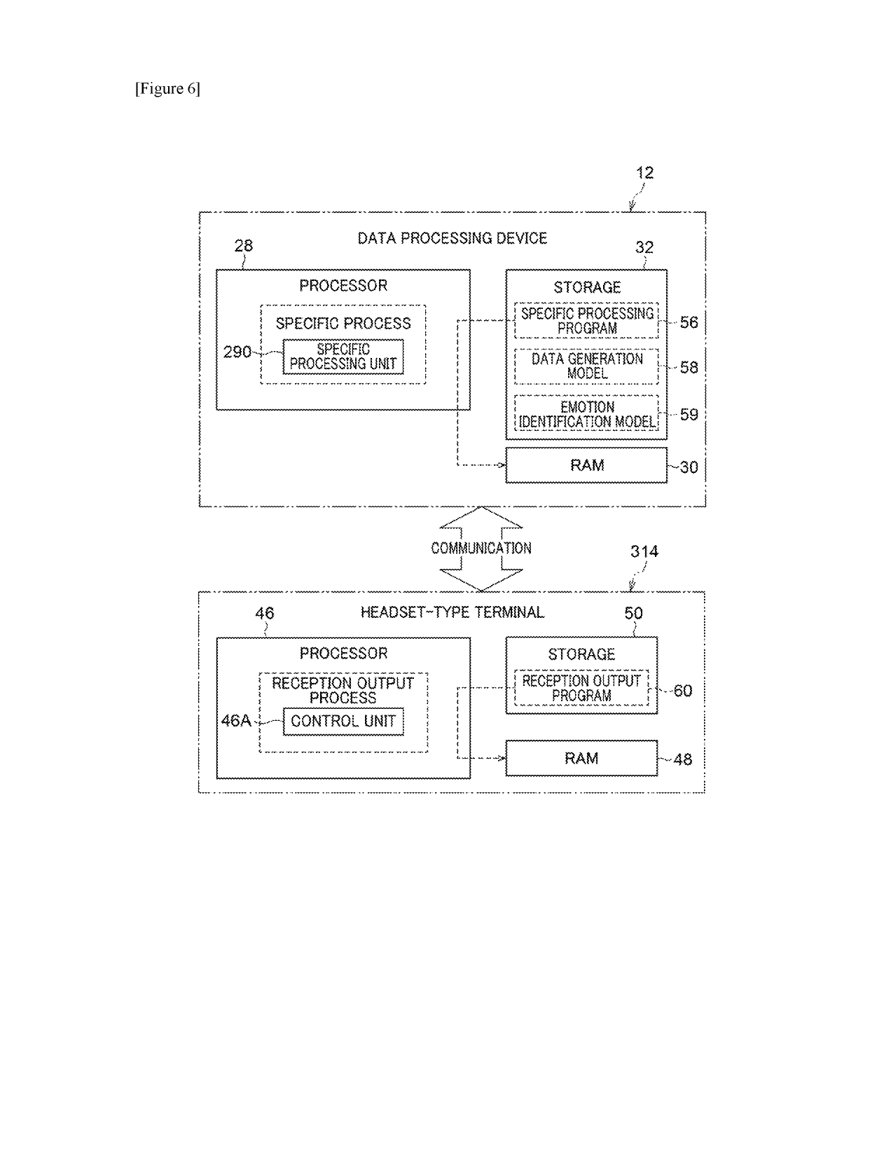

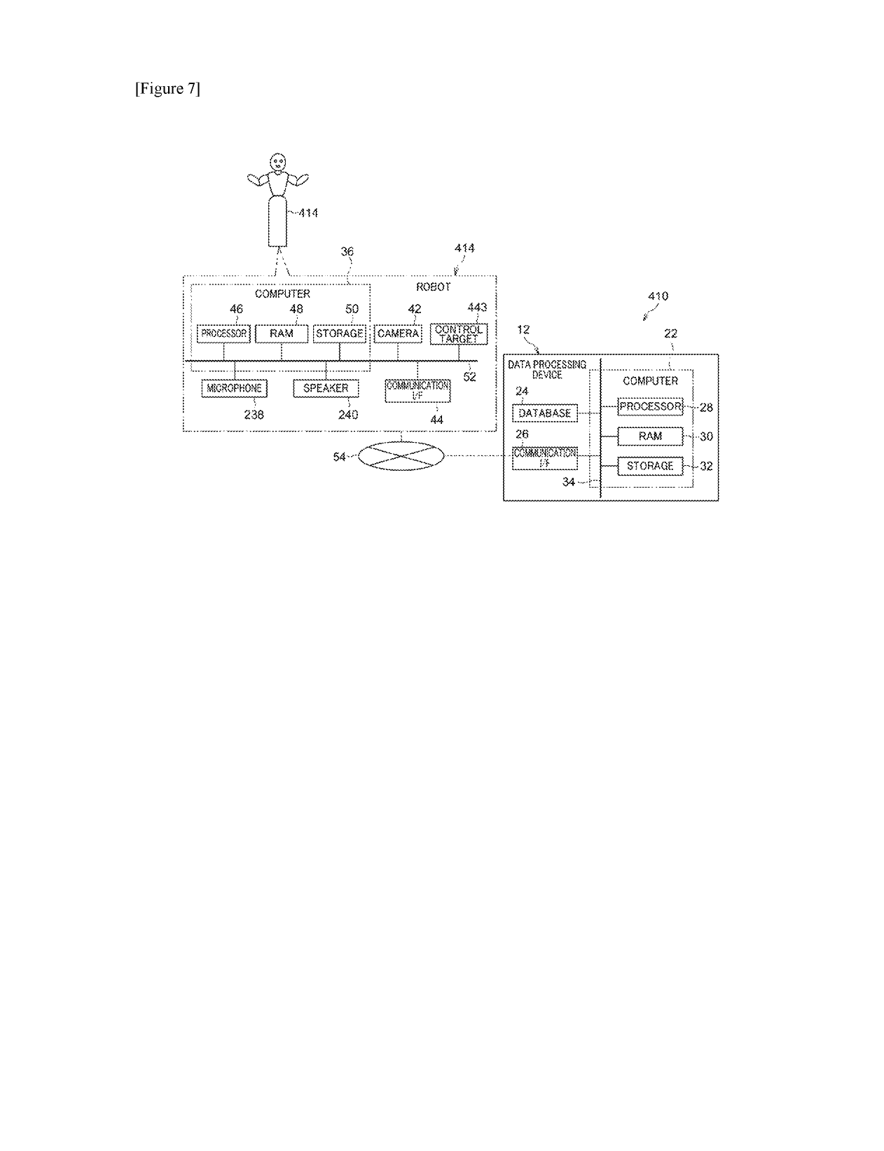

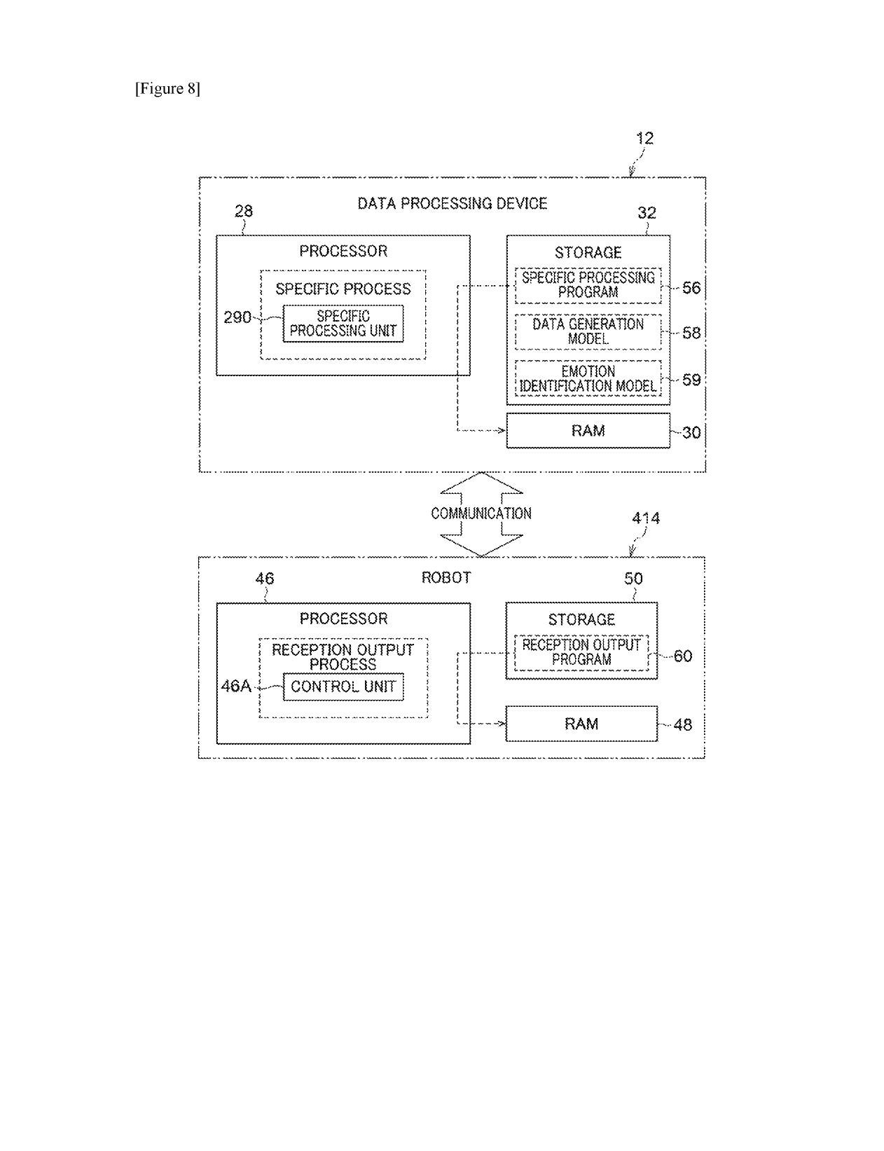

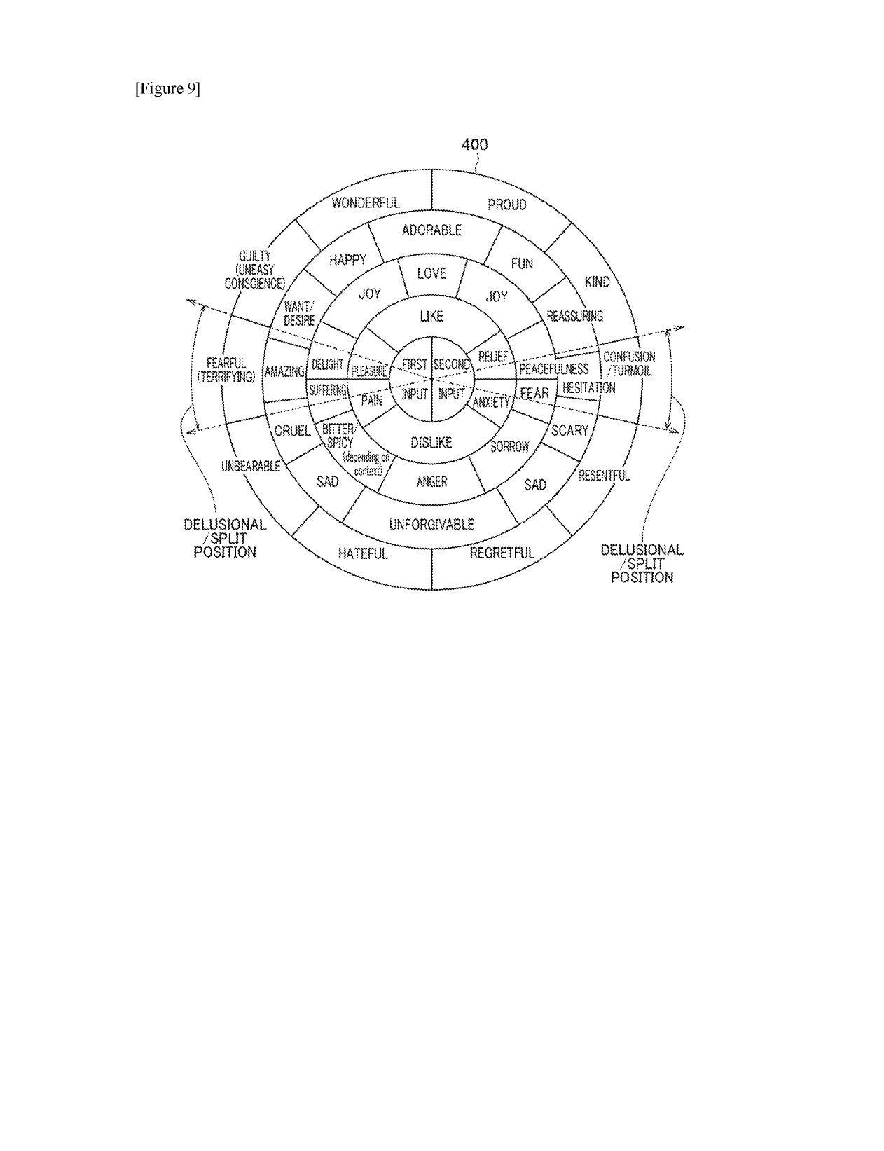

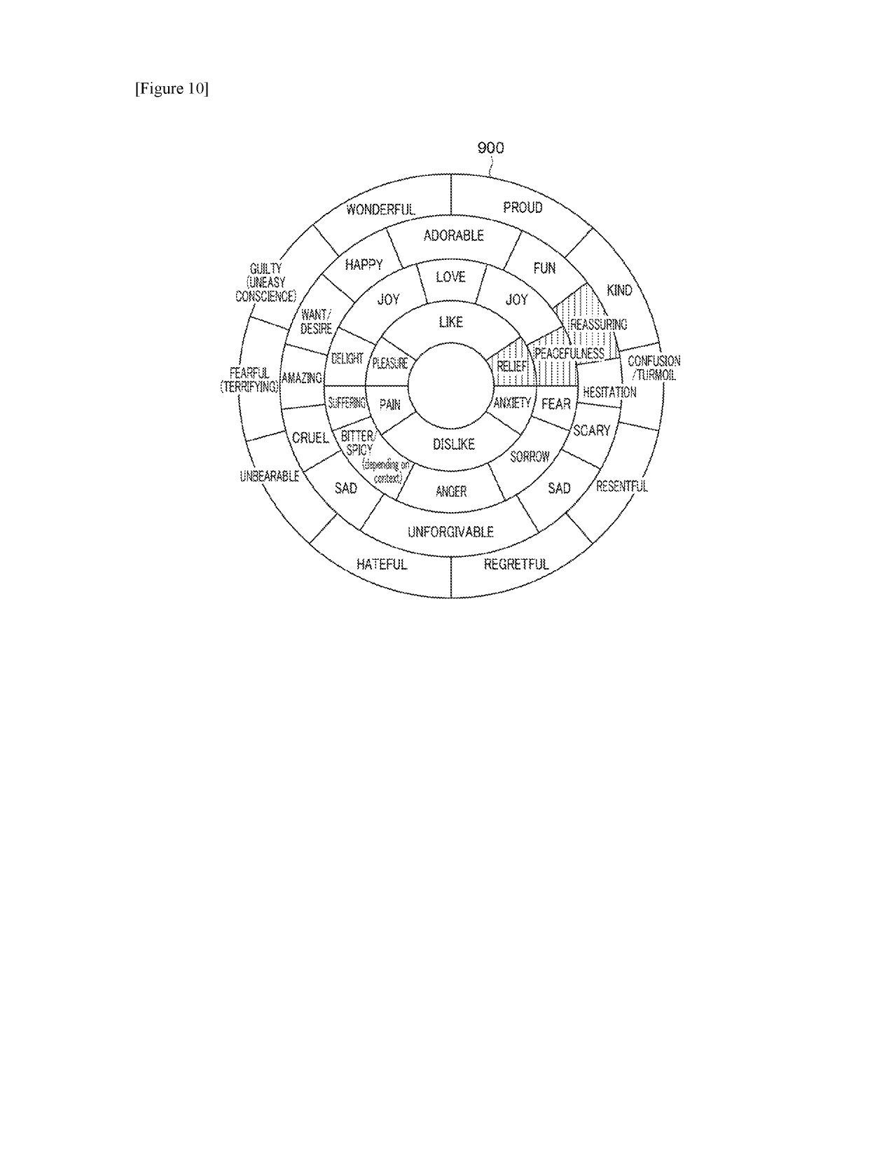

### BRIEF DESCRIPTION OF THE DRAWING

[FIG. 1] is a conceptual diagram showing an example configuration of the data processing system according to the first embodiment.

[FIG. 2] is a conceptual diagram showing an example of key functions of the data processing device and smart device according to the first embodiment.

[FIG. 3] is a conceptual diagram showing an example configuration of the data processing system according to the second embodiment.

[FIG. 4] is a conceptual diagram showing an example of the main functions of the data processing device and smart glasses according to the second embodiment.

[FIG. 5] is a conceptual diagram showing an example configuration of a data processing system according to a third embodiment.

[FIG. 6] is a conceptual diagram showing an example of the main functions of the data processing device and headset terminal related to the third embodiment.

[FIG. 7] is a conceptual diagram showing an example configuration of a data processing system according to the fourth embodiment.

[FIG. 8] is a conceptual diagram showing an example of the main functions of the data processing device and robot according to the fourth embodiment.

[FIG. 9] shows an emotion map onto which multiple emotions are mapped.

[FIG. 10] shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor (hereinafter simply referred to as a "processor") may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used as working memory by the processor.

In the following embodiments, the signed storage is one or more non-volatile storage devices that store various programs and various parameters, etc. Examples include flash memory (SSD (Solid State Drive)), magnetic disks (e.g., hard disks), or magnetic tapes.

In the following embodiments, the communication I/F (Interface) is an interface including a communication processor and an antenna, etc. The communication I/F governs communication between multiple computers. Examples of communication standards applicable to the communication I/F include wireless communication standards such as 5G (5th Generation Mobile Communication System), Wi-Fi (registered trademark), or Bluetooth (registered trademark).

In the following embodiments, "A and/or B" is synonymous with "at least one of A and B." That is, "A and/or B" means it may be only A, only B, or a combination of A and B. Furthermore, in this specification, when three or more items are expressed connected by "and/or," the same concept applies as for "A and/or B".

### First Embodiment

FIG. 1 shows an example configuration of the data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. The reception device 38, output device 40, and camera 42 are also connected to the bus 52.

The reception device 38 includes a touch panel 38A and a microphone 38B, among other components, and receives user input. The touch panel 38A receives user input via contact with an indicator (e.g., a pen or finger) by detecting such contact. The microphone 38B receives voice-based user input by detecting the user's voice. The control unit 46A transmits data indicating the user input received via the touch panel 38A and microphone 38B to the data processing unit 12. Within the data processing unit 12, the specific processing unit 290 acquires the data indicating the user input.

The output device 40 includes a display 40A and a speaker 40B, among other components. It presents data to the user 20 by outputting it in a form perceptible to the user 20 (e.g., audio and/or text). The display 40A displays visual information such as text and images according to instructions from the processor 46. The speaker 40B outputs audio according to instructions from the processor 46. The camera 42 outputs audio according to instructions from the processor 46. The camera 42 is a compact digital camera equipped with an optical system, including a lens, aperture, and shutter, and an imaging element, such as a CMOS (Complementary Metal-Oxide-Semiconductor) image sensor or a CCD (Charge Coupled Device) image sensor.

The communication I/F 44 is connected to the network 54. The communication I/Fs 44 and 26 manage the exchange of various information between processor 46 and processor 28 via network 54.

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The reception output program 60 is stored in the storage 50. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc.). Next, an example of processing by the data processing system 10 according to the first embodiment will be described.

### Example 1

The flow of the specific processing in Example 1 is described below. The components of the system described below are implemented by the data processing device 12 and the smart device 14. The data processing device 12 is referred to as the "server," and the smart device 14 is referred to as the "terminal."

### Implementation Examples for Carrying Out the Invention

The embodiment for implementing the present invention will now be described in further detail. This system is realized using a server and a terminal, and the functions of each part are described below.

First, the generative AI unit is implemented on the server. This unit utilizes a cloud computing environment and possesses the capability to process vast amounts of demographic data and market research data. Specifically, the server retrieves data such as age, gender, occupation, income, residence, education level, hobbies, and lifestyle from a database. Based on this data, it uses machine learning algorithms to generate pseudo-users. For example, the server can model consumer behavior in a specific region and generate pseudo-users reflecting that region's unique culture and economic conditions. It can also generate pseudo-users with industry-specific needs by considering trends within a particular industry.

The pseudo-user generation unit is also implemented on the server. Based on instructions from the generative AI unit, it creates specific pseudo-user profiles. These profiles contain detailed attribute information, such as the pseudo-user's purchase history, brand preferences, and online behavior patterns. Based on this information, the server can create scenarios to evaluate the acceptability of a service in a specific target market in detail. For example, it can simulate how young consumers react to new technology products.

The information provision unit is implemented on both the server and the terminal. The server prepares detailed information about the new business service for the generated pseudo-users and sends it to the terminal. The terminal displays this information to the pseudo-users via the user interface. Specifically, the terminal provides high-resolution videos or infographics for users who prefer visual information, and text-based materials for users who prefer detailed explanations. Furthermore, the terminal has the capability to record user interactions in real time and send feedback to the server. This enables the simulated users to correctly understand the service and exhibit appropriate responses.

The Response Simulation Unit is primarily implemented on the server. This unit simulates responses such as the degree of interest in the service, purchase intent, price sensitivity, and comparative evaluation against competing services, based on each simulated user's profile. Specifically, the server uses deep learning technology to model the complex decision-making processes of simulated users and predict their responses under different scenarios. For example, it can evaluate changes in purchase intent when prices fluctuate or the likelihood of brand switching when competing products enter the market.

Finally, the data aggregation and analysis unit is also implemented on the server. This unit aggregate reaction data obtained from simulated users and analyzes it using statistical methods. Specifically, the server employs big data analytics technology to process vast datasets in real time, evaluating the service's market potential, identifying target user segments, optimizing pricing, and assessing competitive advantages. For instance, it can visualize service acceptance within specific user segments and provide intuitive insights to management through heatmaps and dashboards.

Thus, the embodiments of the present invention provide a system that combines a server and terminals to efficiently and effectively evaluate the market acceptability of new business services, offering a powerful tool for companies to enhance the likelihood of service success prior to market launch.

### System Configuration

The system according to this embodiment comprises a generative AI unit, a pseudo-user generation unit, an information provision unit, a reaction simulation unit, and a data aggregation and analysis unit. The Generative AI Unit utilizes a cloud computing environment and possesses the capability to process vast amounts of demographic data and market research data. This unit retrieves data such as age, gender, occupation, income, residence, education level, hobbies, and lifestyle from databases. Based on this data, it uses machine learning algorithms to generate pseudo-users. For example, it can model consumer behavior in a specific region and generate pseudo-users reflecting that region's unique culture and economic conditions. It can also generate pseudo-users with industry-specific needs by considering trends within particular sectors. Furthermore, prompt text fed to the generative AI can include scenarios like: "A 20-something urban IT professional consumer evaluating a new smartphone." Predict how urban IT professionals in their 20s will react to a new smartphone," "Simulate how middle-aged service workers in rural areas will respond to a new health food product," or "Simulate the reaction of middle-aged and older service industry workers living in rural areas to new health foods."

The pseudo-user generation unit creates specific pseudo-user profiles based on instructions from the generative AI unit. These profiles contain detailed attribute information, such as the pseudo-user's purchase history, brand preferences, and online behavior patterns. Based on this information, the server can create scenarios to evaluate the detailed acceptability of a service within a specific target market. For example, it can simulate how young consumers react to new technology products. It can also assess how users loyal to a specific brand respond to a competing brand's new product. Furthermore, it can generate pseudo-users considering factors like online shopping frequency and review site rating tendencies.

The information provision unit prepares detailed information about the new business service for the generated pseudo-users and transmits it to the terminal. The terminal displays this information to the pseudo-users via the user interface. Specifically, the terminal provides high-resolution videos or infographics to users who prefer visual information, and text-based materials to users who prefer detailed explanations. Furthermore, the terminal has the capability to record user interactions in real time and send feedback to the server. For example, it can analyze how much of a video a user watched and where they showed interest. It can also track actions such as users downloading materials or clicking specific links.

The response simulation unit simulates reactions such as the degree of interest in the service, purchase intent, price sensitivity, and comparative evaluation against competing services based on each pseudo-user's profile. Specifically, the server uses deep learning technology to model the complex decision-making process of pseudo-users and predict their reactions under different scenarios. For example, it can evaluate changes in purchase intent when prices fluctuate or the likelihood of brand switching when competing products enter the market. It can also simulate the impact of specific advertising campaigns on user purchase motivation. Furthermore, it can analyze how users' social media comments and ratings influence other users' purchasing behavior.

The data aggregation and analysis unit aggregates response data obtained from simulated users and analyzes it using statistical methods. Specifically, the server uses big data analytics technology to process vast datasets in real time, evaluating a service's market potential, identifying target user segments, optimizing pricing, and assessing competitive advantages. For example, it can visualize service acceptance within specific user segments and provide intuitive insights to management through heatmaps and dashboards. It can also track fluctuations in the service's market share by comparing it with historical data. Furthermore, it can perform scenario analysis under different market conditions to predict future market trends.

### Implementation Steps

Step 1: Generate Pseudo-Users

In this step, generative AI is used to generate pseudo-users. The generative AI leverages a cloud computing environment to process vast amounts of demographic and market research data. Specifically, it uses machine learning algorithms to generate pseudo-users with diverse attributes based on data such as age, gender, occupation, income, residence, education level, hobbies, and lifestyle. For example, it can model consumer behavior in a specific region and generate pseudo-users reflecting that region's unique culture and economic conditions. Specific examples of prompt sentences fed to the generative AI include: "Predict how consumers in their 20s, living in urban areas, and working in IT-related fields would show interest in a new smartphone," or "Simulate the reaction of middle-aged and older individuals living in rural areas and working in the service industry to a new health food product."

Step 2: User Profile Creation

The pseudo-user generation unit creates specific pseudo-user profiles based on instructions from the generative AI. These profiles contain detailed attribute information, such as the pseudo-user's purchase history, brand preferences, and online behavior patterns. Based on this information, the server can create scenarios to evaluate the detailed acceptability of a service within a specific target market. For example, it can simulate how young consumers react to new technology products. It can also assess how users loyal to a specific brand respond to a competing brand's new product.

Step 3: Information Provision

The information provision unit prepares detailed information about the new business service for the generated pseudo-users and sends it to the terminal. The terminal displays this information to the pseudo-users via the user interface. Specifically, the terminal provides high-resolution videos or infographics to users who prefer visual information, and text-based materials to users who prefer detailed explanations. Furthermore, the terminal has the capability to record user interactions in real time and send feedback to the server. For example, it can analyze how much of a video a user watched, and at which points they showed interest.

Step 4: Response Simulation

The reaction simulation unit simulates responses such as the degree of interest in the service, purchase intent, price sensitivity, and comparative evaluation against competing services based on each pseudo-user's profile. Specifically, the server uses deep learning technology to model the complex decision-making process of pseudo-users and predict their reactions under different scenarios. For example, it can evaluate changes in purchase intent when prices fluctuate or the likelihood of brand switching when competing products enter the market. It can also simulate the impact of specific advertising campaigns on users' purchasing intent.

Step 5: Data Aggregation and Analysis

The data aggregation and analysis unit aggregate the response data obtained from simulated users and analyzes it using statistical methods. Specifically, the server uses big data analytics technology to process vast datasets in real time, evaluating the service's market potential, identifying target user segments, optimizing pricing, and assessing competitive advantages. For example, it can visualize service acceptance within specific user segments and provide intuitive insights to management through heatmaps and dashboards. It can also track fluctuations in the service's market share by comparing it with historical data.

### Specific Use Cases

For instance, when considering the market launch of a new health food product, the present invention's system can be utilized. The generative AI unit targets health-conscious consumers and generates pseudo-users based on data such as age, gender, health status, dietary habits, and exercise routines. Examples of prompts fed to the generative AI include: "Predict how health-conscious consumers in their 30s living in urban areas will react to a new protein bar" or "Simulate the purchase intent of middle-aged and older consumers living in rural areas who are interested in maintaining their health toward a new vitamin supplement."

The pseudo-user generation unit creates specific pseudo-user profiles based on instructions from the generative AI unit. These profiles include past health food purchase histories, brand preferences, and online health information search histories. This enables the creation of scenarios for detailed evaluation of consumer acceptance within specific health food markets.

The Information Provision Department provides detailed information about new health foods to the generated pseudo-users. Specifically, it customizes and provides information such as the product's nutritional components, health benefits, usage methods, and pricing based on the pseudo-user's profile. For example, it can provide information emphasizing the muscle-building effects of protein bars to users with exercise habits, and information highlighting the immune-boosting effects of vitamin supplements to users prioritizing health maintenance.

The Response Simulation Unit simulates reactions for each pseudo-user based on their profile, including their level of interest in the health food, purchase intent, price sensitivity, and comparative evaluation against competing products. For example, it can evaluate changes in purchase intent when prices fluctuate or the likelihood of brand switching if a competing product enters the market. It can also simulate the impact of specific advertising campaigns on users' purchasing motivation.

The Data Aggregation and Analysis Unit aggregates the response data obtained from the simulated users and analyzes it using statistical methods. This enables the assessment of the market potential for health foods, the identification of target user segments, the optimization of pricing, and the evaluation of competitive advantages. For example, it can visualize the acceptability of health foods within specific user segments, providing intuitive insights to management. It can also track fluctuations in the market share of health foods by comparing with historical data.

### Application Example 1

The flow of specific processing in Application Example 1 is described below. The components of the system described below are implemented by the data processing device 12 and the smart device 14. The data processing device 12 is referred to as the "server," and the smart device 14 is referred to as the "terminal."

### Implementation Examples for the Present Invention

The embodiment for implementing the present invention is described in further detail below. This system is intended for operating simulations of autonomous vehicles and includes a generative AI unit, a simulation unit, and a data aggregation and analysis unit.

First, the generative AI unit is described. This unit possesses the capability to generate diverse traffic conditions and environmental scenarios based on traffic data, weather data, and road infrastructure information. It utilizes a cloud computing environment and has the capacity to process vast amounts of data in real time. Specifically, it can generate real-time traffic scenarios using historical traffic flow data and signal cycle information to reproduce traffic congestion during urban rush hours. For example, it can simulate congestion occurrence by detailed modeling of vehicle flow at specific intersections and adjusting signal timing and vehicle density. It can also create environments considering fog or rain effects based on weather data to simulate poor visibility during nighttime suburban driving. For instance, by varying fog density or rainfall intensity, it can evaluate the impact of changing visibility on vehicle operation. Furthermore, detailed terrain models based on road infrastructure information can be constructed to reproduce mountainous sharp curves and road conditions during construction. For example, considering road gradients and curve radii, it is possible to simulate vehicle driving stability and braking distances.

Next, the simulation unit is described. This unit simulates the operation of autonomous vehicles based on generated traffic conditions and environmental parameters. It evaluates in detail how vehicles respond, considering sensor data, control algorithms, and operational routes. For instance, to verify a vehicle's response to sudden lane changes, it can simulate the vehicle's steering control and speed adjustment algorithms. Specifically, it evaluates the vehicle's skid and stability during lane changes to determine if a safe lane change is possible. Furthermore, to assess the effectiveness of emergency braking in response to a pedestrian darting out, it can analyze the vehicle's brake system response time and braking distance in detail. For instance, the accuracy of pedestrian detection sensors and the timing of brake control can be adjusted to derive optimal control parameters ensuring safety in emergencies. Furthermore, scenarios for cooperative driving utilizing vehicle-to-vehicle communication can be created to verify responses to vehicles running red lights and adaptation to vehicle flow across multiple lanes. For example, algorithms can be developed to predict the movement of vehicles running red lights through information sharing between vehicles and take appropriate evasive actions.

The data aggregation and analysis unit are described below. This unit aggregates data obtained from simulations and analyzed it using statistical methods. It can evaluate the safety, efficiency, and ride comfort of autonomous vehicles and identify areas for improvement. For example, it can perform risk assessments based on simulation data to propose measures for reducing accident risks in specific traffic conditions. Specifically, it analyzes accident occurrence frequency and causes to identify risk factors, thereby formulating accident prevention strategies. Furthermore, it can analyze vehicle energy consumption data to derive optimal driving patterns for route optimization aimed at improving fuel efficiency. For instance, it can propose optimal speed control and route selection to minimize energy consumption. Additionally, it can perform analyses based on ride comfort data to propose improvements in acceleration/deceleration control for enhanced passenger comfort. Specifically, it develops control algorithms to minimize vibration and shaking during acceleration/deceleration, providing a comfortable ride experience.

Thus, the embodiments of the present invention combine a generative AI unit, a simulation unit, and a data collection and analysis unit to efficiently and effectively simulate the operation of autonomous vehicles, providing valuable insights to enhance safety and efficiency. This reduces risks in actual operation and enables safer and more efficient operation of autonomous vehicles.

### System Configuration

The system according to this embodiment comprises a generative AI unit, a simulation unit, and a data aggregation and analysis unit. The generative AI unit has the capability to generate diverse traffic conditions and environmental conditions based on traffic data, weather data, and road infrastructure information. This unit utilizes a cloud computing environment and possesses the ability to process vast amounts of data in real time. For example, to reproduce traffic congestion during urban rush hour, it can generate real-time traffic scenarios using historical traffic flow data and signal cycle information. Specifically, it can simulate congestion occurrence by detailed modeling of vehicle flow at specific intersections and adjusting signal timing and vehicle density. Furthermore, to simulate poor visibility during suburban nighttime driving, it can create environments considering the effects of fog or rain based on weather data. For instance, by varying fog density or rainfall intensity, the impact of changing visibility on vehicle operation can be evaluated. Furthermore, detailed terrain models based on road infrastructure data can be constructed to recreate conditions like sharp mountain curves or roadwork zones. For example, considering road gradients and curve radii enables simulation of vehicle handling stability and braking distances. Specific examples of prompts for the generative AI include: "Simulate traffic congestion during rush hour in urban areas" or "Reproduce poor visibility during heavy rain on a highway."

The simulation unit possesses the capability to simulate the operation of autonomous vehicles based on generated traffic conditions and environmental parameters. This unit evaluates in detail how the vehicle will react, taking into account sensor information, control algorithms, and the operational route. For example, to verify the vehicle's response to sudden lane changes, it can simulate the vehicle's steering control and speed adjustment algorithms. Specifically, it evaluates the vehicle's skid and stability during lane changes to determine if a safe lane change is possible. Furthermore, to assess the effectiveness of emergency braking in response to a pedestrian darting out, it can analyze the vehicle's brake system response time and braking distance in detail. For instance, it can adjust the accuracy of pedestrian detection sensors and the timing of brake control to derive optimal control parameters ensuring safety in emergencies. Furthermore, it can create cooperative driving scenarios utilizing vehicle-to-vehicle communication to verify responses to vehicles running red lights and adaptation to traffic flow across multiple lanes. For example, through information sharing between vehicles, it can develop algorithms to predict the movements of vehicles running red lights and take appropriate evasive actions.

The Data Aggregation and Analysis Unit aggregates data obtained from simulations and possesses the capability to analyze it using statistical methods. This unit can evaluate the safety, efficiency, and ride comfort of autonomous vehicles and identify areas for improvement. For example, it can perform risk assessments based on simulation data to propose measures for reducing accident risks in specific traffic conditions. Specifically, it analyzes accident occurrence frequency and causes to identify risk factors, thereby formulating accident prevention strategies. Furthermore, to optimize driving routes for improved fuel efficiency, it can analyze vehicle energy consumption data and derive optimal driving patterns. For instance, it can propose optimal speed control and route selection to minimize energy consumption. Additionally, it can perform analyses based on ride comfort data to suggest improvements in acceleration/deceleration control. Specifically, control algorithms can be developed to minimize vibration and shaking during acceleration and deceleration, providing a comfortable ride experience.

Thus, the system according to this embodiment combines a generative AI unit, a simulation unit, and a data collection and analysis unit to efficiently and effectively simulate the operation of autonomous vehicles, providing valuable insights to enhance safety and efficiency. This reduces risks in actual operation and enables safer and more efficient operation of autonomous vehicles.

### Implementation Steps

Step 1: Traffic Condition Generation

In this step, generative AI is used to generate diverse traffic conditions and environmental scenarios. Based on traffic data, weather data, and road infrastructure information, the generative AI creates various scenarios such as rush hour traffic congestion in urban areas, nighttime driving in suburban areas, poor visibility during inclement weather, sharp curves in mountainous regions, and roads under construction. For example, it can simulate congestion occurrence by detailed modeling of vehicle flow at specific intersections and adjusting signal timing and vehicle density. Specific examples of prompt sentences fed to the generative AI include: "Simulate traffic congestion during urban rush hour" or "Reproduce poor visibility during highway driving in heavy rain."

Step 2: Autonomous Driving Simulation

In this step, the operation of autonomous vehicles is simulated based on the generated traffic conditions and environmental parameters. The simulation component evaluates in detail how the vehicle reacts, considering sensor data, control algorithms, and operational routes. For instance, to verify a vehicle's response to sudden lane changes, the steering control and speed adjustment algorithms can be simulated. Furthermore, it is possible to analyze in detail the response time and braking distance of the vehicle's braking system to evaluate the effectiveness of emergency braking in response to pedestrians darting out. Additionally, scenarios for cooperative driving utilizing vehicle-to-vehicle communication can be created to verify responses to vehicles ignoring traffic signals and adaptation to vehicle flow across multiple lanes.

Step 3: Data Aggregation and Analysis

In this step, data obtained from simulations is aggregated and analyzed using statistical methods. The data aggregation and analysis unit can evaluate the safety, efficiency, and ride comfort of autonomous vehicles and identify areas for improvement. For example, it can perform risk assessments based on simulation data to propose measures for reducing accident risks in specific traffic conditions. Furthermore, it can analyze vehicle energy consumption data to derive optimal driving patterns for route optimization aimed at improving fuel efficiency. Additionally, it can perform analyses based on ride comfort data to propose improvements in acceleration/deceleration control for enhanced passenger comfort.

### Specific Use Cases

For example, the present invention's system can be used when operating autonomous vehicles in urban areas. In urban areas, ensuring vehicle safety and efficiency is critical due to high traffic volume, complex intersections, and areas with many pedestrians. This system uses the generative AI unit to generate scenarios that replicate rush-hour traffic congestion in urban areas. Specifically, it models vehicle flow at specific intersections in detail based on historical traffic flow data and signal cycle information, simulating congestion conditions by adjusting signal timing and vehicle density and adjusts signal timing and vehicle density to simulate congestion conditions. Specific examples of prompts fed to the generative AI include "Simulate traffic congestion during urban rush hour" or "Reproduce pedestrian flow at an intersection."

Next, the simulation unit simulates the operation of autonomous vehicles based on the generated traffic conditions. It evaluates in detail how the vehicle reacts, considering sensor information, control algorithms, and operating routes. For example, to verify the vehicle's response to sudden lane changes, it can simulate the vehicle's steering control and speed adjustment algorithms. Furthermore, it can perform detailed analysis of the vehicle's braking system response time and stopping distance to evaluate the effectiveness of emergency braking in response to sudden pedestrian crossings. Additionally, it can create cooperative driving scenarios utilizing vehicle-to-vehicle communication to verify responses to vehicles running red lights and adaptation to traffic flow across multiple lanes.

Finally, the data aggregation and analysis unit aggregates data obtained from simulations and analyzes it using statistical methods. This analysis enables evaluation of the safety, efficiency, and ride comfort of autonomous vehicles, identifying areas for improvement. For example, risk assessments based on simulation data can be performed to propose measures for reducing accident risks in specific traffic conditions. Furthermore, it can analyze vehicle energy consumption data to derive optimal driving patterns for route optimization aimed at improving fuel efficiency. Additionally, it can perform analyses based on ride comfort data to propose improvements in acceleration/deceleration control for enhanced passenger comfort.

In this way, the system of the present invention provides valuable insights for safely and efficiently realizing the operation of autonomous vehicles in urban areas. This enables the reduction of risks in actual operation and the realization of safer and more efficient autonomous vehicle operation.

The specific processing unit 290 transmits the results of the specific processing to the smart device 14. On the smart device 14, the control unit 46A instructs the output device 40 to output the results of the specific processing. The microphone 38B acquires audio indicating user input regarding the results of the specific processing. The control unit 46A transmits the audio data indicating the user input acquired by the microphone 38B to the data processing unit 12. At the data processing unit 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12, etc., includes multiple types of data generation models 58, and the data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. The AI may also be an AI agent. Furthermore, when the processing of the aforementioned components is performed by the AI, such processing may be performed in part or in whole by the AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. Examples of the network 54 include a WAN (Wide Area Network) and/or a LAN (Local Area Network).

Smart glasses 214 include a computer 36, a microphone 238, a speaker 240, a camera 42, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio according to instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

FIG. 4 shows an example of key functions of the data processing device 12 and the smart glasses 214. As shown in FIG. 4, specific processing is performed by the processor 28 in the data processing device 12. The specific processing program 56 is stored in the storage 32.

The specific processing program 56 is an example of a "program" pertaining to the technology of this disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. The reception output processing is performed by the processor 46 acting as a control unit 46A according to the reception output program 60 executed on RAM 48. Note that the smart glasses 214 may also have a data generation model 58 and an emotion identification model 59, and can perform processing similar to that of the identification processing unit 290 using these models.

Next, the identification processing performed by the identification processing unit 290 of the data processing device 12 is described. The components of the system described below are implemented by the data processing device 12 and the smart glasses 214. In the following description, the data processing device 12 is referred to as the "server," and the smart glasses 214 are referred to as the "terminal."

### Example 1

The flow of the specific processing in Example 1 described in the first embodiment is the same as described above, so the explanation is omitted.

### Application Example 1

The flow of the specific processing in Example 1 described in the first embodiment is the same as above, so the description is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. The AI may also be an AI agent. Furthermore, when the processing of the aforementioned components is performed by the AI, such processing may be performed in part or in whole by the AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart glasses 214.

### Third Embodiment

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The headset-type terminal 314 comprises a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on the RAM 30.

Storage 32 stores a data generation model 58 and an emotion identification model 59. The data generation model 58 and the emotion identification model 59 are used by specific processing unit 290.

In the headset-type terminal 314, reception output processing is performed by the processor 46. The reception output program 60 is stored in the storage 50. Processor 46 reads the reception output program 60 from storage 50 and executes the read reception output program 60 on RAM 48. Reception output processing is achieved by processor 46 operating as control unit 46A according to the reception output program 60 executed on RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the "server," and the headset-type terminal 314 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., while the smart device 14 acquires or collects information necessary for processing from the data processing device 12 or external devices, etc.

For example, the collection unit is implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit may be implemented by the specific processing unit 290 of the data processing device 12 and analyze data from the collection unit and acquisition unit. For example, the generation unit may be implemented by the specific processing unit 290 of the data processing device 12 and generate a cooking menu using the generation AI. For example, the provision unit may be implemented by the output device 40 of the smart device 14 or the specific processing unit 290 of the data processing device 12 and provide the generated cooking menu. The correspondence between each unit and the device or control unit is not limited to the examples described above and can be modified in various ways.

The above embodiment described a configuration where specific processing is performed by the data processing device 12. However, the technology disclosed herein is not limited to this, and specific processing may also be performed by the headset-type terminal 314.

### Fourth Embodiment

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eyes, and motors for driving the arms, hands, legs, etc. The posture and gestures of robot 414 are controlled by controlling the motors for the arms, hands, legs, etc. Some of the emotions of robot 414 can be expressed by controlling these motors. Furthermore, the robot's facial expressions can be expressed by controlling the light emission state of the LEDs in its eyes. FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a "program" pertaining to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In robot 414, reception output processing is performed by processor 46. Storage 50 stores a reception output program 60. Processor 46 executes the reception output program 60 stored in storage Read the reception output program 60 from memory location 50 and execute the read reception output program 60 in RAM 48. The reception output processing is realized by the processor 46 operating as the control unit 46A according to the reception output program 60 executed in RAM 48.

Next, the specific processing performed by the specific processing unit 290 of the data processing device 12 is described. The various parts of the system described below are realized by the data processing device 12 and the robot 414. In the following description, the data processing device 12 is referred to as the "server," and the robot 414 is referred to as the "terminal."

### Example 1

The flow of the specific processing is the same as that described in Example 1 of the first embodiment, so the description is omitted.

### Application Example 1

The flow of the specific processing in Example 1 described in the first embodiment is the same as above, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. A prompt containing instructions is input to the data generation model 58, and inference data such as audio data (e.g., data of still images or data of videos) is input. The data generation model 58 infers based on the input inference data according to the instructions indicated by the prompt and outputs the inference result in one or more data formats such as audio data, text data, and image data. The data generation model 58 may include, for example, text generation AI, image generation AI, multimodal generation AI, etc. Here, inference refers to, for example, analysis, classification, prediction, and/or summarization. The specific processing unit 290 performs the specific processing described above using the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged in concentric circles radiating from the center. Emotions closer to the center of the concentric circles represent more primitive states. Emotions representing states or behaviors arising from mental states are placed further out in the concentric circles. Emotion is a concept that includes affect and mental states. On the left side of the concentric circles are generally emotions generated from reactions occurring within the brain. On the right side are generally emotions induced by situational judgment. Above and below the concentric circles are generally emotions generated from reactions occurring within the brain and also induced by situational judgment. Furthermore, the upper part of the concentric circle contains "pleasant" emotions, while the lower part contains "unpleasant" emotions. Thus, the Emotion Map 400 maps multiple emotions based on the structure of their origin, with emotions that tend to occur simultaneously mapped close together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of the emotion map 400 represents the mind, while the outer part represents behavior. Therefore, the further out on the emotion map 400, the more visible the emotion becomes (manifesting in behavior).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. Emotion maps, for example, Dr. Mitsuyoshi's Emotion Map (Research on Speech Emotion Recognition and Neurophysiological Signal Analysis of Emotions, Tokushima University, Doctoral Dissertation: https://ci.nii.ac.jp/naid/500000375379). The left half of the emotion map displays emotions belonging to the "Reaction" area, where sensory perception dominates. The right half of the emotion map displays emotions belonging to the "Situation" domain, where situational awareness is dominant.

Two emotions that promote learning are defined in the emotion map. One is the negative emotion around the center of the "repentance" or "reflection" area on the situation side. That is, when the robot experiences negative emotions like "I never want to feel this way again" or "I don't want to be scolded anymore." The other is the positive emotion around "desire" on the reaction side. That is, when the robot feels positive emotions like "I want more" or "I want to know more."

The emotion identification model 59 inputs the user input into a pre-trained neural network, obtains emotion values corresponding to each emotion shown in the emotion map 400, and determines the user's emotion. This neural network is pre-trained based on multiple training data sets, which are combinations of user input and emotion values corresponding to each emotion shown in the emotion map 400. Furthermore, this neural network is trained such that emotions positioned close to each other, as shown in Emotion Map 900 in FIG. 10, have similar values. FIG. 10 illustrates an example where multiple emotions, such as "reassurance," "tranquility," and "confidence," have similar emotion values.

The above description primarily explains the system of the present disclosure in terms of the functions of the data processing device 12. However, the system of the present disclosure is not necessarily implemented on a server. The system of the present disclosure may be implemented as a general information processing system. For example, the present disclosure may be implemented as a software program operating on a personal computer or as an application operating on a smartphone or similar device. The method of the present disclosure may be provided to users in a SaaS (Software as a Service) format.

The above embodiments illustrated a configuration where specific processing is performed by a single computer 22. However, the technology of this disclosure is not limited thereto. Distributed processing may be performed by multiple computers, including computer 22, for specific processing. For example, data generation model 58 may be provided on an external device of data processing device 12, and said external device may generate data corresponding to input data. For example, the data generation model 58 may be provided in an external device of the data processing device 12, and data generation corresponding to input data may be performed in said external device.

The above embodiment described a configuration where a specific processing program 56 is stored in storage 32, but the technology disclosed herein is not limited to this. For example, the specific processing program 56 may be stored on a portable, computer-readable non-volatile storage medium such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 is downloaded and installed on the computer 22.

It should be noted that it is not necessary to store the entire specific processing program 56 in a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., programs. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing tasks. Each processor incorporates or connects to memory and executes specific processing by utilizing this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be a single processor.

Examples of configurations using a single processor include: First, a configuration where one processor is formed by combining one or more CPUs with software, with this processor functioning as the hardware resource executing the specific processing. Second, there is a form using a processor that implements the entire system's functionality, including multiple hardware resources executing specific processing, on a single IC chip, as exemplified by a System-on-a-chip (SoC). Thus, specific processing is implemented as a hardware resource using one or more of the various processors described above.

Furthermore, regarding the hardware structure of these various processors, more specifically, electrical circuits combining circuit elements such as semiconductor devices can be employed. Moreover, the specific processing described above is merely one example. Therefore, it goes without saying that within the scope of not deviating from the main purpose, unnecessary steps may be omitted, new steps may be added, and the processing order may be changed.

The above description and illustrations provide a detailed explanation of the aspects pertaining to the technology of the present disclosure and represent merely one example of the technology disclosed herein. For example, the above descriptions of configurations, functions, operations, and effects are merely examples of configurations, functions, operations, and effects pertaining to the technical aspects of the present disclosure. Therefore, it goes without saying that within the scope not deviating from the spirit of the present disclosure's technology, unnecessary portions may be omitted, new elements added, or replacements made to the above-described content and illustrated content. Furthermore, to avoid complexity and facilitate understanding of the technical aspects of the present disclosure, descriptions of common technical knowledge and the like that are not particularly necessary for enabling the present disclosure to have been omitted from the above descriptions and illustrations.

All references, patent applications, and technical specifications cited herein are incorporated by reference to the same extent as if each reference, patent application, and technical specification were specifically and individually cited herein.

### The following further discloses the above embodiments.

### Supplementary Note 1

A system comprising a generative AI unit, a simulation unit, and a data collection and analysis unit. The generative AI unit has the capability to generate diverse traffic conditions and environmental scenarios based on traffic data, weather data, and road infrastructure information. It can create various scenarios such as rush hour traffic congestion in urban areas, nighttime driving in suburban areas, poor visibility during inclement weather, sharp curves in mountainous regions, and roads under construction. The simulation unit simulates the operation of autonomous vehicles based on the generated traffic conditions and environmental factors. It evaluates how the vehicles respond by considering sensor information, control algorithms, and operational routes. The data collection and analysis unit aggregates data obtained from the simulations, analyzes it using statistical methods, and evaluates the safety, efficiency, and ride comfort of the autonomous vehicles, thereby identifying areas for improvement.

A system as described in Supplementary Note 1, wherein the Generative AI Unit generates diverse traffic conditions and environmental factors based on traffic data, weather data, and road infrastructure information, such as rush-hour traffic congestion in urban areas, nighttime driving in suburban areas, poor visibility during inclement weather, sharp curves in mountainous regions, and roads under construction. The generative AI unit utilizes cloud computing to possess the capability to process vast amounts of data and can employ prompt sentences such as "Simulate traffic congestion during urban rush hour" or "Reproduce poor visibility during highway driving in heavy rain" as input for the generative AI.

The system described in Supplementary Note 1, wherein the simulation unit simulates the operation of autonomous vehicles based on the generated traffic conditions and environmental conditions, verifying the vehicle's response to sudden lane changes, the effectiveness of emergency braking against pedestrians darting out, responses to vehicles ignoring traffic signals, adaptation to vehicle flow across multiple lanes, and obstacle avoidance in narrow alleys. The simulation unit collects data to enhance vehicle safety and operational efficiency, enabling it to propose measures to reduce accident risks in specific traffic situations and optimize driving routes for improved fuel efficiency.

### EXPLANATION OF SYMBOLS

10, 210, 310, 410 Data Processing System

12 Data Processing Device

14 Smart Device

214 Smart Glasses

314 Headset-type devices

414 Robot

What is claimed is:

1. A data processing system, comprising:
a data processing device including:
a processor,
a volatile memory,
a non-volatile storage storing a specific processing program, a generative artificial intelligence model, and an emotion identification model,
a database storing demographic data and market research data, and
a communication interface connected to a network; and
at least one terminal device including:
a processor,
a display and speaker configured to output information,
at least one input device including a microphone and/or a camera configured to acquire multimodal input data, and
a communication interface configured to exchange data with the data processing device in a secure state,
wherein execution of the specific processing program by the processor of the data processing device causes the data processing device to:
generate, using the generative artificial intelligence model implemented as a trained neural network, a plurality of pseudo-user profiles based on the demographic data and the market research data, each pseudo-user profile including at least age, occupation, income, residence, and behavioral attributes;
generate service presentation data customized for each pseudo-user profile, the service presentation data including at least one of purpose, features, usage methods, benefits, or pricing;
transmit the service presentation data to the terminal device for output via the display and/or speaker;
receive from the terminal device multimodal response data including at least one of text data, audio data, or image data;
input the multimodal response data into the emotion identification model, the emotion identification model being trained to output emotion values corresponding to positions on a predefined emotion map in which emotions are spatially arranged according to psychological origin and behavioral manifestation;
simulate, using the generative artificial intelligence model and the emotion values, behavioral reaction data including at least purchase intent and price sensitivity; and
aggregate and statistically analyze the behavioral reaction data to generate at least one quantitative market evaluation metric, and
wherein the system performs iterative adjustment of service presentation parameters based on the emotion values to generate updated simulation results.

2. The system of claim 1, wherein the emotion map comprises concentric layers representing primitive internal states and outward behavioral expressions, and wherein emotions mapped adjacently produce similar output vectors from the emotion identification model.

3. The system of claim 1, wherein the generative artificial intelligence model comprises at least one of a transformer-based language model, a convolutional neural network, or a recurrent neural network trained using deep learning.

4. The system of claim 1, wherein the terminal device records interaction metrics including video playback duration, link selection behavior, or download activity, and transmits the interaction metrics to the data processing device for inclusion in the behavioral reaction data.

5. The system of claim 1, wherein at least part of the generative artificial intelligence model is executed on an external cloud computing device and inference results are returned to the data processing device via the communication interface.

6. The system of claim 1, wherein processing is distributively executed by a plurality of processors including at least one CPU and at least one FPGA or ASIC.

7. A vehicle operation simulation system, comprising:
a generative scenario unit executed by a processor and configured to generate traffic and environmental scenarios based on traffic data, weather data, and road infrastructure data;
a vehicle simulation unit configured to simulate operation of an autonomous vehicle using sensor models, vehicle control algorithms, and vehicle-to-vehicle communication models under the generated scenarios; and
a data aggregation and analysis unit configured to collect simulation output data and compute safety and efficiency metrics,
wherein the generative scenario unit uses a trained neural-network-based generative model to vary at least one of signal cycle timing, vehicle density, fog density, rainfall intensity, road gradient, or curve radius to produce multiple environmental permutations, and
wherein the vehicle simulation unit computes at least steering response, braking distance, response time to pedestrian detection, and energy consumption for each environmental permutation.

8. The system of claim 7, wherein rush-hour congestion is reproduced by modeling vehicle flow at a specific intersection and dynamically adjusting signal timing and vehicle density.

9. The system of claim 7, wherein emergency braking performance is evaluated by modifying pedestrian detection sensor accuracy parameters and brake actuation timing.

10. The system of claim 7, wherein cooperative driving scenarios are generated using vehicle-to-vehicle communication to predict movement of vehicles violating traffic signals.

11. The system of claim 7, wherein the data aggregation and analysis unit performs statistical risk assessment by analyzing accident frequency and causal factors derived from simulation data.

12. The system of claim 7, wherein optimal driving routes are determined by minimizing simulated energy consumption across a plurality of route candidates.

13. A non-transitory computer-readable medium storing instructions that, when executed by one or more processors of a data processing device, cause the data processing device to:
receive a prompt containing structured scenario instructions;
input the prompt and associated inference data into a generative artificial intelligence model comprising a deep neural network capable of multimodal inference;
output generated content in at least one of text, audio, or image format;
process user interaction data using an emotion identification neural network trained to output emotion values corresponding to mapped positions on a predefined emotion map;
adjust one or more generation parameters of the generative artificial intelligence model based on the emotion values; and
output emotion-adaptive generated content,
wherein the adjustment of the generation parameters is performed iteratively until a predefined convergence condition of emotion values is satisfied.

14. The computer-readable medium of claim 13, wherein the emotion identification neural network is trained using training data sets comprising combinations of user input data and emotion value vectors.

15. The computer-readable medium of claim 13, wherein the generative artificial intelligence model is fine-tuned to output inference results even when the prompt omits explicit instructions.

16. The computer-readable medium of claim 13, wherein the inference data includes at least one of speech audio captured by a microphone or image data captured by a camera.

17. The computer-readable medium of claim 13, wherein processing is selectively performed by either a server processor or a terminal processor based on available computational resources.

18. The computer-readable medium of claim 13, wherein the instructions are downloadable from a remote server and installed prior to execution.
